(19) United States
(12) Patent Application Publication
(10) Pub. No.: US 2009/0179537 A1
(43) Pub. Date: Jul. 16, 2009

(54) Casing Structure of a Portable Computer

(76) Inventors: Takayuki Morino, Yamato-shi (JP); Kimio Kumada, Fujisawa-shi (JP); Tetsuya Ohtani, Yokohama-shi (JP); Kenshin Yonemochi, Kamakura-shi (JP)

Correspondence Address: DILLON & YUDELL LLP, 8911 N. CAPITAL OF TEXAS HWY, SUITE 2110, AUSTIN, TX, 78759, US

(21) Appl. No.: 12/348,597

(22) Filed: Jan. 5, 2009

(30) Foreign Application Priority Data
Jan. 15, 2008 (JP) 2008-005395

(51) Int. Cl. H02B 1/26

(52) U.S. Cl. 312/223.2

(57) ABSTRACT

A portable computer is disclosed. The portable computer includes a display casing and a system casing. The display casing is configured to accommodate a display. The system casing is configured to accommodate electronic devices. A keyboard assembly is disposed on a surface of the system casing. A palm rest is provided to cover a portion of the surface of the system casing. An intermediate member having design parts covering a peripheral portion of the keyboard assembly and a support portion disposed under the palm rest.

### PRIORITY CLAIM

The present application claims benefit of priority under 35 U.S.C. §§120, 365 to the previously filed Japanese Patent Application No. JP2008-005395 entitled, “Portable Computer” with a priority date of Jan. 15, 2008, which is incorporated by reference herein.

### BACKGROUND OF THE INVENTION

1. Technical Field

The present invention relates to portable computers in general, and in particular to a casing structure of a portable computer.

2. Description of Related Art

A notebook personal computer (PC) typically has a system casing and a display casing mounted on the system casing to be openable by means of a hinge. A keyboard and a decorative panel are mounted on the surface of the system casing. The system casing generally requires a variety of capabilities such as strength capable of protecting electronic devices accommodated therein, heat insulation capable of suppressing surface temperature at locations contacted by a user, light weight, thin profile, etc.

The system casing has a structure configured by a box-like casing body having sufficient strength and constituting a shell, called a monocoque structure, a keyboard assembly disposed thereon, and a decorative panel covering a perimeter thereof. A portion of the decorative panel disposed in front of the keyboard assembly is referred to as a palm rest that supports the hands of a user operating the keyboard. The decorative panel is commonly made of synthetic resin.

### SUMMARY OF THE INVENTION

In accordance with a preferred embodiment of the present invention, a portable computer includes a display casing and a system casing. The display casing is configured to accommodate a display. The system casing is configured to accommodate electronic devices. A keyboard assembly is disposed on a surface of the system casing. A palm rest is provided to cover a portion of the surface of the system casing. An intermediate member having design parts covering a peripheral portion of the keyboard assembly and a support portion disposed under the palm rest.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is an isomeric view of a notebook PC, in accordance with a preferred embodiment of the present invention;

FIG. 2 is an exploded view of a system casing-side structure of the notebook PC from FIG. 1;

FIG. 3 is a top view of a keyboard assembly mounted on a frame of an intermediate member;

FIG. 4 is an isomeric view of a support portion of an intermediate member;

FIG. 5 is a top view of a palm rest mounted on the support portion; and

FIG. 6 is a cross-sectional view of the support portion from FIG. 4.

### DETAILED DESCRIPTION OF A PREFERRED EMBODIMENT

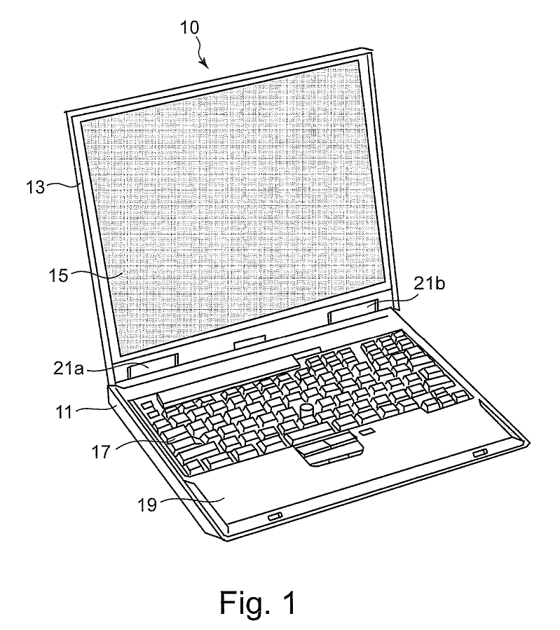

Referring now to the drawings and in particular to FIG. 1, there is depicted an isomeric view of a notebook personal computer (PC), in accordance with a preferred embodiment of the present invention. As shown, a notebook PC 10 includes a liquid crystal display (LCD) module 15 accommodated within a display casing 13. A system casing 11 accommodates system devices (not shown) such as a processor, a motherboard, a wireless module and a hard disk drive. A keyboard assembly 17 and a palm rest 19 are mounted on an upper surface of system casing 11. System casing 11 and display casing 13 are openably coupled to each other via hinges 21a and 21b.

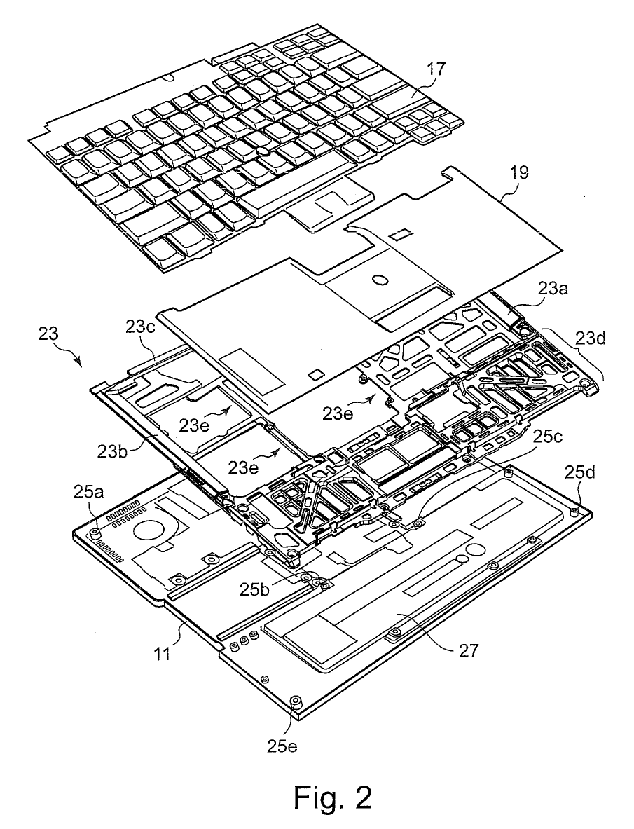

With reference now to FIG. 2, there is illustrated an exploded view of system casing 11 of notebook PC 10 from FIG. 1. System casing 11 is formed of a light metal by means of molding, and a set of tapping bosses 25a-25e is formed on a bottom surface thereof. On system casing 11 accommodating the system devices, an intermediate member 23 is mounted on tapping bosses 25a-25d so that a space for accommodating the system devices is provided between intermediate member 23 and a bottom surface of system casing 11. Intermediate member 23 is provided with design parts 23a, 23b and 23c in the perimeter of keyboard assembly 17 so as to be exposed when display casing 13 is opened.

Intermediate member 23 is also provided with a frame 23e under keyboard assembly 17 for mounting keyboard assembly 17, and a support portion 23d at a lower part of palm rest 19 for supporting against a pressure applied to palm rest 19 by the hands of a user operating a keyboard. Design parts 23a-23c, frame 23e, and support portion 23d are formed, by integral molding, of die-cast light alloys of magnesium or aluminum, for example. A battery pack 27 is disposed under support portion 23d.

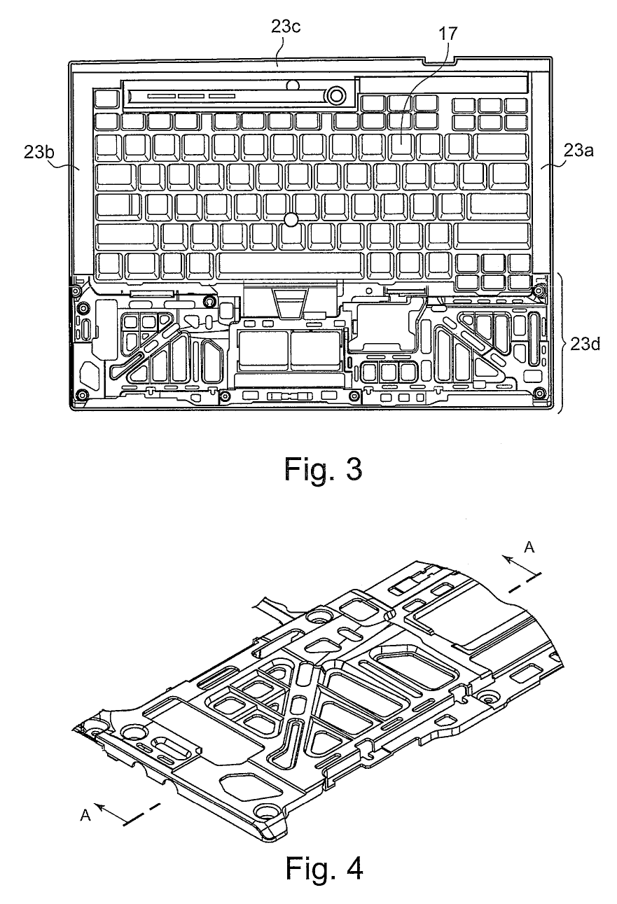

Referring now FIG. 3, there is depicted a top view of intermediate member 23 mounted on system casing 11, and keyboard assembly 17 mounted on frame 23e of intermediate member 23. Design parts 23a-23c are disposed on three sides of keyboard assembly 17. In intermediate member 23, design parts 23a-23c exhibit the function of a keyboard bezel mounted on a system casing having a conventional monocoque or dual structure while support portion 23d exhibits the function of a skeletal member employed in a system casing having the conventional dual structure.

With reference now to FIG. 4, there is illustrated an isomeric view of support portion 23d. Support portion 23d, which is disposed at the lower part of palm rest 19, performs a function of supporting a pressure applied to palm rest 19 and thus protecting the internal system devices or stably holding the user's hands. A cross-sectional view along A-A of support portion 23d is shown in FIG. 6. As shown in FIG. 6, support portion 23d is configured into a three-dimensional shape having plate-like ribs 101a and 101b and a bridge-shaped rib 105. Support portion 23d is further provided with opening portions 103a, 103b and 103c so that support portion 23d includes a light weight structure with added strength.

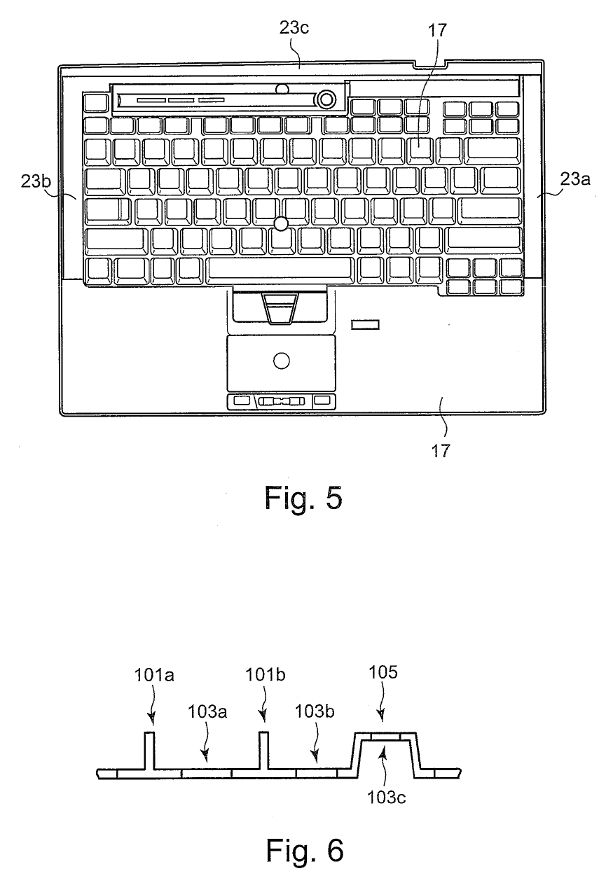

Referring now to FIG. 5, there is depicted a top view of palm rest 19 mounted on support portion 23d of FIG. 4. Since palm rest 19 does not require too much strength, the material and structure of palm rest 19 can be decided based on consideration of only the designing function and the heat insulation effect. Palm rest 19 can be formed of an ABS resin or a PC resin having lower heat conductivity than metal. Furthermore, since palm rest 19 is formed of a material different from intermediate member 23, the surface temperature of palm rest 19 will not rise even when battery pack 27, which tends to generate a large amount of heat, is disposed under support portion 23d. As a result, a user should not experience an unpleasant feeling.

As has been described, the present invention provides a casing structure of a portable computer.

While the invention has been particularly shown and described with reference to a preferred embodiment, it will be understood by those skilled in the art that various changes in form and detail may be made therein without departing from the spirit and scope of the invention.

What is claimed is:

1. A portable computer comprising:
a display casing for accommodating a display;
a system casing for accommodating a plurality of electronic devices;
a keyboard assembly disposed on a surface of said system casing;
a palm rest covering a portion of said surface of said system casing; and
an intermediate member having design parts covering a peripheral portion of said keyboard assembly and a support portion disposed under said palm rest.

2. The portable computer of claim 1, wherein said support portion is configured by an opening portion and a plurality of ribs.

3. The portable computer of claim 2, wherein said plurality of ribs includes a plate-like rib and a bridge-shaped rib.

4. The portable computer of claim 1, wherein said portable computer includes a battery pack disposed under said palm rest.

5. The portable computer of claim 1, wherein said intermediate member is made of a light metal via integral molding.

6. The portable computer of claim 1, wherein said palm rest is made of synthetic resin.

7. The portable computer of claim 1, wherein said display is a liquid crystal display.

8. The portable computer of claim 1, wherein said system casing and said display casing are openably coupled to each other via at least one hinge.
